(19) United States
(12) Patent Application Publication
(10) Pub. No.: US 2004/0028791 A1
(43) Pub. Date: Feb. 12, 2004

(54) Serial flour products having multi-flavor, multi-variety, and rich nutrition

(76) Inventor: Ke-Yi Li, Shanghai (CN)

Correspondence Address: Raymond Y. Chan, Suite 128, 108 N. Ynez Ave., Monterey Park, CA, 91754, US

(21) Appl. No.: 10/630,003

(22) Filed: Jul. 29, 2003

(30) Foreign Application Priority Data
Aug. 6, 2002 (CN) 022664040.2

(51) Int. Cl. A21D 10/00

(52) U.S. Cl. 426/549

(57) ABSTRACT

A serial flour product having multi-flavor, multi-variety, and rich nutrition, includes a predetermined amount of flavor material which is comminuted from a material such as vegetables, fruits, sea foods, domestic birds, wild birds, plants, fungus, or condiments, wherein the flavor material is in form of juice, granules or powder, wherein the flavor material is added into flour to form a composite material. For a single new product, the flavor is able to be single-flavor and single-nutrition, or multi-flavor and multi-nutrition, or even composite flavor and composite nutrition. For the serial flour products, the flavor is able to be single-flavor and single-nutrition, or multi-flavor and multi-nutrition, or even composite flavor and composite nutrition. The combination of the flour products and a filing, such as meat granules, contained therein is able to be single-flavor and single-nutrition, or multi-flavor and multi-nutrition, or even composite flavor and composite nutrition.

### CROSS REFERENCE OF RELATED APPLICATION

The present invention claims priority of a foreign patent application in the Peoples Republic of China having an application date of Aug. 5, 2002 and an application number of 02266040.2.

### FIELD OF THE PRESENT INVENTION

The present invention relates to a serial of flour products having multi-flavor, multi-variety, and rich nutrition, and more particularly to the flour products that are able to renovate and replace the conventional ones.

### BACKGROUND OF THE PRESENT INVENTION

Regarding to the conventional flour products, varieties are rarely renovated, flavors remains unchanged, and nutrition is far from complete and perfect. In view of the current flour products such as steamed bun, meat stuffed bun, mooncake, cake, sweet dumpling, refection, instant noodle, noodle, and all Chinese refection, it is found that although there are a lot of varieties, the flavors have not changed much. Most of them only have natural, salty and/or sweet taste as before. Although sometimes there are some differences in terms of taste and nutrition, it depends on the changing of filings for example shrimp, meat of birds, or pork. It is becoming harder and harder for the taste of such flour products to meet the growing requirement of people for delicious food.

### SUMMARY OF THE PRESENT INVENTION

The main object of the invention is to renovate a taste of traditional Chinese flour products which only have natural, salty and/or sweet taste. A serial flour product having multi-flavor, multi-variety, and rich nutrition, is produced by adding a certain amount of juice, granules, fine granules, or powder of one or more flavor materials such as vegetables, fruits, sea foods, domestic birds, wild birds, plants, fungus, or condiments into dry, wet or fermented flour, and adding a certain amount of water and then producing a series of semi- or finished bean products. The product is able to be a composite material; the flavor thereof is able to be composite flavor; the nutrition is able to be composite nutrition; for a single new product, the flavor is able to be single-flavor and single-nutrition, or multi-flavor and multi-nutrition, or even composite flavor and composite nutrition; for the serial flour products, the flavor is able to be single-flavor and single-nutrition, or multi-flavor and multi-nutrition, or even composite flavor and composite nutrition.

Another object of the invention is to provide a combination of the flour products and a filing, such as meat granules, contained therein, which is single-flavor and single-nutrition, or multi-flavor and multi-nutrition, or even composite flavor and composite nutrition.

Another object of the invention is to provide a serial flour product having multi-flavor, multi-variety, and rich nutrition, which is produced by adding a certain amount of juice, granules, fine granules, or powder of more than one flavor materials, and then adding a certain amount of water or not.

### BRIEF DESCRIPTION OF THE DRAWINGS

FIG. 1 is a schematic view of one embodiment of the invention showing a process of the invention.

FIG. 2 is a schematic view of another embodiment of the invention showing another process of the invention.

### DETAILED DESCRIPTION OF THE PREFERED EMBODIMENT

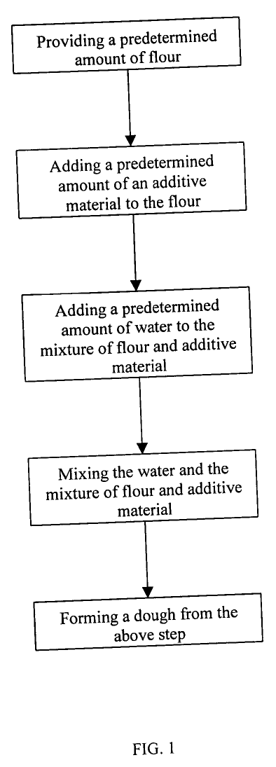

Referring to FIG. 1, a serial flour products having single-flavor, multi-variety, and rich nutrition, are produced as following:

preparing a certain amount of flour;

adding a certain a mount of juice, granules, fine granules, or powder of one flavor materials such as vegetables, fruits, sea foods, domestic birds, wild birds, plants, fungus, and condiments into the flour;

adding a certain amount of water and mixing;

producing a series of semi-finished product; and

producing finished product.

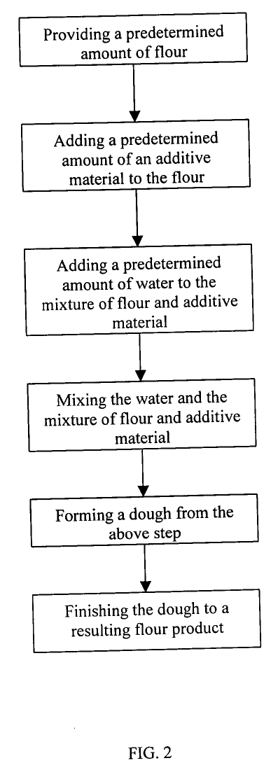

With reference to FIG. 2, a serial flour products having multi-flavor, multi-variety, and rich nutrition, are produced as following:

prepare a certain amount of flour;

adding a certain amount of juice, granules, fine granules, or powder of more than one flavor materials such as vegetables, fruits, sea foods, domestic birds, wild birds, plants, fungus, and condiments into the flour;

adding a certain amount of water and mixing;

producing a series of semi-finished product; and

producing finished product.

The produced semi- or finished product is a novel food. It not only effectively improves the color, smell, and taste of such kind of bean products, but also adjusts the nutritious combination thereof, and also increases the quality and level thereof. It sets up a new generation of serial foods being convenient, useful, and various.

Compared with conventional flour products, the tastes and nutrition of the novel products are much improved and increased, keeping original natural, salty, and/or sweet taste thereof. A novel serial flour products having multi-flavor, multi-variety, and rich nutrition can be produced through combining different raw materials and flavor material.

More than one different flavor materials or the juice, granules, fine granules, or powder thereof are able to be mixed together to create a new combination. The product is able to be a composite material. The flavor thereof is able to be composite flavor. The nutrition is able to be composite nutrition. For a single new product, the flavor is able to be single-flavor and single-nutrition, or multi-flavor and multi-nutrition, or even composite flavor and composite nutrition. For the serial bean products, the flavor is able to be single-flavor and single-nutrition, or multi-flavor and multi-nutrition, or even composite flavor and composite nutrition.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure form such principles. Therefore, this invention includes all modifications encompassed within the spirit and scope of the following claims.

What is claimed is:

1. A serial flour product having multi-flavor, multi-variety, and rich nutrition, being produced by adding a certain amount of juice, granules, fine granules, or powder of one or more flavor materials such as vegetables, fruits, sea foods, domestic birds, wild birds, plants, fungus, or condiments into dry, wet or fermented flour, and adding a certain amount of water and then producing a series of semi- or finished bean products, whereby through adding the flavors and nutrition of said flavor material, the tastes and nutrition of the novel products are much improved and increased, keeping the original natural, salty, or sweet taste thereof; more than one different said flavor materials or the juice, granules, fine granules, or powder thereof are able to be mixed together to create a new combination; the product is able to be a composite material; the flavor thereof is able to be composite flavor; the nutrition is able to be composite nutrition; for a single new product, the flavor is able to be single-flavor and single-nutrition, or multi-flavor and multi-nutrition, or even composite flavor and composite nutrition; for the serial flour products, the flavor is able to be single-flavor and single-nutrition, or multi-flavor and multi-nutrition, or even composite flavor and composite nutrition; the combination of said flour products and a filing, such as meat granules, contained therein is able to be single-flavor and single-nutrition, or multi-flavor and multi-nutrition, or even composite flavor and composite nutrition.

2. The flour product, as claimed in claim 1, wherein more than one different said flavor materials or the juice, granules, fine granules, or powder thereof are able to be mixed together to create a new combination; the product is able to be a composite material; the flavor thereof is able to be composite flavor; the nutrition is able to be composite nutrition; for a single new product, the flavor is multi-flavor and multi-nutrition, or even composite flavor and composite nutrition; for the serial flour products, the flavor multi-flavor and multi-nutrition, or composite flavor and composite nutrition.

3. The flour product, as claimed in claim 1, wherein one said flavor materials or the juice, granules, fine granules, or powder thereof is added into said a raw material of bean product; for a single new product, the flavor is single-flavor; for the serial bean products, the flavor is single-flavor.

4. The flour product, as claimed in claim 3, wherein more than one different said flavor materials or the juice, granules, fine granules, or powder thereof are able to be mixed together to create a new combination; the product is able to be a composite material; the flavor thereof is able to be composite flavor; the nutrition is able to be composite nutrition; for a single new product, the flavor is multi-flavor and multi-nutrition, or even composite flavor and composite nutrition; for the serial flour products, the flavor multi-flavor and multi-nutrition, or composite flavor and composite nutrition.

5. The flour product, as claimed in claim 1, wherein the combination of one said flour products and one said filing, such as meat granules, contained therein is single-flavor and single-nutrition.

6. The flour product, as claimed in claim 5, wherein the combination of more than one flour products and one said filing, such as meat granules, contained therein is multi-flavor and multi-nutrition, or even composite flavor and composite nutrition.

7. A process of producing a kind of bean food, comprising the steps of:
(a) preparing a certain amount of one or more kind of flour;
(b) comminuting a certain amount of one or more flavor materials such as vegetables, fruits, sea foods, domestic birds, wild birds, plants, fungus, and condiments into juice, granules, fine granules, or powder;
(c) adding said comminuted flavor material into said flour;
(d) adding a certain water or not;
(e) fully mixing;
(f) mixing said flour with said flavor material;
(g) enveloping a filling with the mixed material made in step (f);
(h) producing a semi-finished flour product; and
(i) producing a finished flour product.
